(19) United States
(12) Patent Application Publication
(10) Pub. No.: US 2005/0041688 A1
(43) Pub. Date: Feb. 24, 2005

(54) Packet transmission method, packet aggregation and disaggregation devices

(75) Inventors: Raphael Bernhard, Le Cannet (FR); Emmanuel Besson, Mougins Le Haut (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: FRANCE TELECOM, Paris (FR)

(21) Appl. No.: 10/917,566

(22) Filed: Aug. 13, 2004

(30) Foreign Application Priority Data
Aug. 20, 2003 (FR) 0310050

(51) Int. Cl. H04L 12/28; H04J 3/24

(52) U.S. Cl. 370/473; 370/537; 370/389; 370/395.1

(57) ABSTRACT

A packet transmission method, in which first packets are sent by source stations (5, 6, 7) to target stations (8, 9), the source and target stations being connected via a packet mode data network (1), in which first packets (P1, P2, P3), chosen according to at least the size and the target station of each first packet from a set of first packets sent by source stations, are aggregated to form respective second packets (Pu) of the same protocol level as the first packets; when a second packet satisfies a determined transmission criterion, the second packet is sent to an address determined as a function of the target stations intended to receive first packets aggregated in the said second packet.

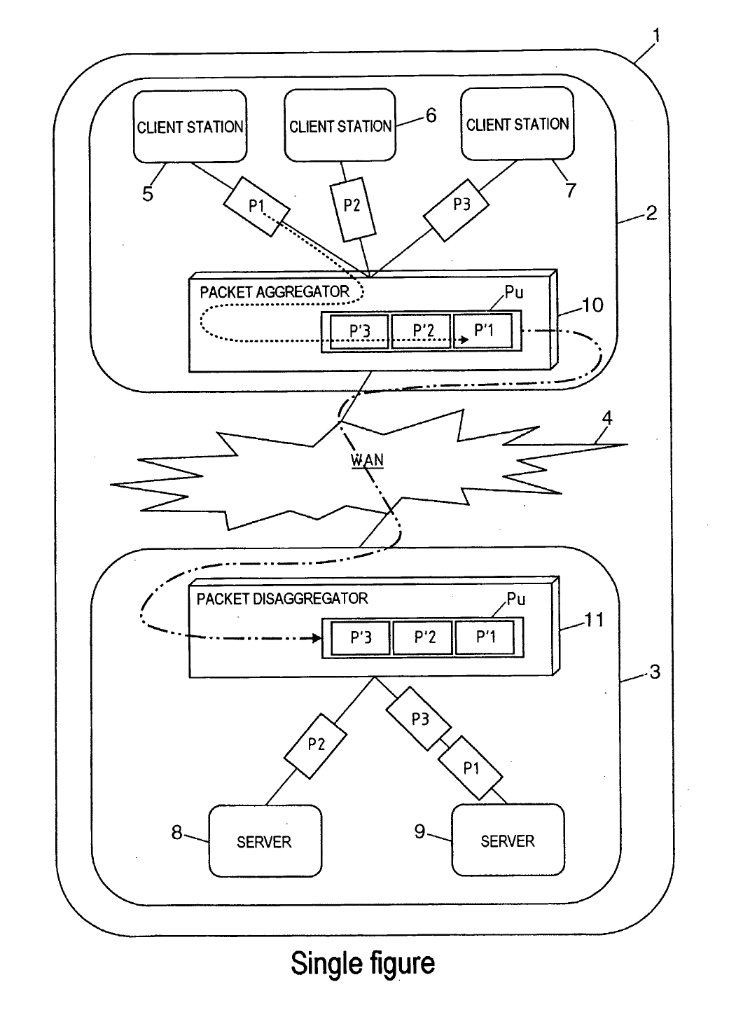

The present invention concerns the field of packet mode transmissions in data networks.

The data network is for example an IP (Internet Protocol) network.

In some cases, such a data network is required to transport a large number of small packets in bursts. Such a situation occurs for example when applying the ICA (Independent Computing Architecture) protocol. This protocol, devised by Citrix (http://www.citrix.com), is used to generate remotely over the network the display of applications running on a server. This protocol, which is based on standard network infrastructures such as TCP/IP (Transmission Control Protocol/Internet Protocol), has the fault of generating bursts comprising a large number of small packets. For example, each mouse movement on the station on which the display is generated remotely generates a very small packet which is sent to the server.

In the context of low bit rate networks or networks offering no high quality of service, the considerable quantities of small packets thus generated may cause congestion at several levels. To begin with, congestion may occur at the level of network. Specifically, a large number of packets containing very little payload information must be transported in the network, which causes a sudden increase of the bandwidth required.

Congestion may also occur at the level of equipment. All the packets sent in a short period must be processed by physical equipment (a router for example), which causes an increase in the load on this equipment, and even saturation.

Several techniques have been proposed to tackle this problem. They consist mainly of the principles of traffic smoothing and of assigning priorities to data streams. The following solutions may be quoted for example: PacketShaper from Packeteer (www.packeteer.com/products/packetshaper.cfm), IP/boss from Ipanema Technologies (www.Ipanematech.com) or the solutions of Expand Networks (http://www.expand.com).

The basic principle of all these solutions consists in putting on the local area network interconnection equipment which receives all the traffic (like a router). When such equipment is installed, the user defines a set of rules which are to be used to associate a priority to each packet arriving at the equipment. This priority is used to decide the waiting delay (zero where appropriate) observed by the equipment for transferring the packet to the destination network.

This type of equipment assigns priorities and regulates packet streams, but does not deal with all the problems caused on the network by the bursts of small packets induced by this protocol, because all these small packets still exist and still have to be handled over the whole network.

Another known solution lies in a functionality used to make the packets created by the movements of the station mouse form a queue at the ICA client.

The aim of the present invention is to propose a method and devices to overcome the aforementioned disadvantages.

Thus, according to a first aspect, the invention proposes a packet transmission method, wherein first packets are sent by source stations to target stations, the source and target stations being linked via a packet mode data network, comprising the following steps:
aggregating first packets, chosen according to at least the size and the target station of each first packet from a set of first packets sent by source stations, to form respective second packets of the same protocol level as the first packets;
when a second packet satisfies a determined transmission criterion, sending the second packet to an address determined as a function of the target stations intended to receive the first packets aggregated in said second packet.

The method according to the invention is thus used to mutualize a number of packets into a single packet, in order to increase network performance overall. Packets sent by several geographically close sources with particular characteristics (for example small packets) can be assembled and sent over the network in the form of a single packet containing all the original packets.

This technique allows reducing the number of packets that have to be switched in the network, and therefore in particular to reduce the load on the equipment such as the routers. It also allows better use to be made of the network resources by creating packets whose characteristics (for example the size) are ideal for the network.

The invention thus markedly increases the network performance of information systems which use for example the ICA protocol and which are deployed on low bit rate wide area networks (WAN).

According to a second aspect, the invention proposes a device for aggregating first packets sent by source stations to target stations, the source and target stations being linked via a packet mode data network, comprising means for applying the steps of a method according to the first aspect of the invention.

According to a third aspect, the invention proposes a device for disaggregating second packets identified by a determined address, in a packet mode data network and comprising source stations sending first packets to target stations, the said second packets being obtained following the application of a method according to the first aspect of the invention. This disaggregation device comprises:
means of receiving a second packet;
means of extracting each first packet aggregated in the received second packet;
means of sending each extracted first packet to a respective target station.

Other features and advantages of the invention will be further apparent on reading the following description. This is purely illustrative and must be read with reference to the appended drawings in which:
the single FIGURE is a diagram of a system applying the invention.

The single FIGURE shows a data network 1 comprising a first Local Area Network (LAN) 2 and a second Local Area Network 3. These two LANs 2 and 3 are connected via a Wide Area Network (WAN) 4.

Stations communicating with one another are distributed in different sub-networks of the network 1. The single FIGURE depicts three stations 5, 6 and 7 in the LAN 2. In the LAN 3 there are in particular two stations 8 and 9. In the embodiment considered here, the stations 8 and 9 are for example servers supplying to the client stations 5, 6 and 7 services causing these client stations to generate a multitude of small packets P addressed in return to the servers 8, 9. As an example, it is considered hereafter that the two servers use with the client stations 5, 6, 7 the same aforementioned ICA protocol supported by the network 1.

A packet aggregation module 10 is also part of the LAN 2.

In one embodiment of the invention shown in the single FIGURE, the client stations 5, 6, 7 send the ICA packets, that they emit towards the servers 8 and 9, first to the packet aggregation module 10. The non-ICA packets are sent in the conventional manner. When the latter has sufficient small packets or after a certain period, it sends these packets aggregated in the form of a single packet Pu.

In a network of the prior art, the stations 5, 6, 7 would send the packets directly to the servers. As a result, to route packets, Pi,_{i=1, . . . , m,} the network would have to switch these m packets.

The single FIGURE represents three ICA packets successively received by the packet aggregation module 10, originating from the stations 5, 6 and 7: the packet P1 sent by the station 5 to the server 9, the packet P2 sent by the station 6 to the server 8 and the packet P3 sent by the station 7 to the server 9.

The packet aggregation module 10 progressively aggregates these packets while checking after each new aggregation a pre-established transmission criterion. If the transmission criterion is not satisfied, the aggregation of new received packets continues. When it is satisfied, the packet thus constituted is transmitted, the new packets being aggregated in a new packet.

Advantageously, the packets Pi,_{i=1,2,3}, are stored in the packet Pu in a reduced form Pi′,_{i=1,2,3} because certain information common to P1, P2, P3 may be deleted and factorized in Pu. For example, these factorized data in the situation depicted in the single FIGURE comprise data relating to the identification of the LAN 3, to which each packet P1, P2, P3 is addressed. In another type of constituted aggregated packet in which all the constituent packets have the same destination server, the data relating to the destination server address (IP address and destination port) are factorized.

The fact that packets having common characteristics are aggregated also means that a compression functionality can be put in place.

Furthermore, if these common characteristics remain identical throughout the connection, they may be transmitted only once on initialization of the system and then systematically deleted from all the packets. For example, by aggregating all the packets intended for one and the same port on one and the same IP address defined on system initialization, the number of this port and the IP address can be deleted from all the interchanges.

Suppose that the packet Pu resulting from the aggregation of the three packets P1, P2, P3 satisfies the transmission criterion (as a function of the packets to be aggregated and of the transmission criterion, the distribution within an aggregated packet could be different at another time, for example four packets originating from the station 5, one packet from the station 7 and zero packets from the station 6).

The packet Pu constituted by the aggregation module 10 is then sent to an address corresponding to a packet disaggregation module 11 forming part of the LAN 3, the common transition point of each of the packets P1, P2, P3 aggregated in Pu.

On receipt of the packet Pu by the packet disaggregation module 11, the latter reconstitutes the packet P1 by reintegrating into P1 some or all of the data factorized in Pu. It then sends P1 to its initial destination, that is to say the server 9.

The reverse path (response from a server station to a client station) is obtained by simple symmetry of the method described above.

In the embodiment considered in the single FIGURE, all the ICA packets that are sent on one and the same local area network (LAN) and that are all intended for a second LAN have been aggregated.

Other aggregation criteria may be chosen. Thus, the following can also be aggregated:
only packets of the same type (for example ICA) or, on the contrary, of different types, with or without a maximum size condition;
packets originating from one and the same LAN and intended for one and the same port of one and the same IP address, which for example is used to deal with the problem of bursts of small packets from the source LAN;
packets originating from one and the same subset of a LAN and intended for one and the same port of one and the same IP address, which, in addition, is used to deal with the priorities of data streams originating from different subsets of client stations on the source LAN.

Several successive aggregation steps may be carried out at different locations of the network 1.

For example, aggregations can be carried out on packets already resulting from an aggregation.

The transmission criterion may comprise different aspects. It may for example establish a minimum size (which may correspond to an optimal size relative to the processing capabilities of the network, evaluated by the network administrator) beyond which a packet Pu may be sent.

It may also take account of the result of a comparison between a maximum waiting delay and a waiting delay computed based on the waiting delays, from their arrival at the aggregation module 10, of the packets P1, P2, P3 of the packet Pu being constituted. The computed delay may be the average waiting delay of the aggregated packets, or the waiting delay of the packet Pi which arrived the earliest of the packets aggregated in Pu, etc. If the computed delay is equal to or greater than the maximum waiting delay, the packet is sent.

The criterion may be a combination of different conditions, for example, the packet Pu is sent as soon as one of the conditions is satisfied (or as soon as all the conditions are satisfied, etc).

These criteria may differ depending on the aggregation modules considered in the network.

Furthermore, they may be adjusted dynamically according to parameters relative to the data network 1. These adjustments modify the behaviour of the aggregation modules and thus allow best use to be made of the network capabilities at a given moment.

The network parameters used to define the adjustments are for example information regularly collected in the network, for example relating to:
load rate (CPU, memory, etc.) of the different routers traversed by the large packet,
number of clients sending small packets (this value changes every time a new user logs on),
occupancy rate of the WAN network,
type of WAN network (each type of network defines an ideal packet size).

1. A packet transmission method, wherein a plurality of packets are sent by source stations to target stations the source and target stations being linked via a packet mode data network, the method comprising:
aggregating a subset of the plurality of packets into a single aggregated packet of the same protocol level as the subset, wherein the packets of the subset are chosen according to at least the size and the target station of each of the plurality of packets sent by source stations; and
when the aggregated packet satisfies a determined transmission criterion, sending the aggregated packet to an address determined as a function of the target stations intended to receive the subset of the plurality of packets.

2. The method according to claim 1, wherein the aggregating step is carried out further as a function of the source station of each first packet.

3. The method according to claim 1, wherein the respective source stations of each of the subset are part of a single local area network.

4. The method according to claim 1, wherein the respective target stations of each of the subset form the same part of a single local area network.

5. The method according to claim 1, wherein the packets of the subset are chosen because they all have a common target station.

6. The method according to claim 1, further comprising:
prior to the sending step, deleting, from a packet of the subset, data that is common to multiple packets of the subset.

7. The method according to claim 6, wherein said data is incorporated into the aggregated packet.

8. The method according to claim 1, wherein the transmission criterion is based at least in part on a comparison of the size of the aggregated packet with a defined minimum size.

9. The method according to claim 1, wherein the transmission criterion is based at least in part on a determination of whether a maximum delay time for transmission of the aggregated packet has been reached.

10. The method according to claim 1, wherein the transmission criterion is adjusted dynamically at least as a function of parameters of the data network.

11. The method according to claim 1, further comprising, at the determined address:
receiving the aggregated packet;
extracting each of the subset of packets; and
sending each extracted packet to its target station.

12. A device for aggregating packets respectively sent by source stations to target stations, these source and target stations being linked via a packet mode data network, the device comprising:
means for aggregating a subset of the plurality of packets into a single aggregated packet of the same protocol level as the subset, wherein the packets of the subset are chosen according to at least the size and the target station of each of the plurality of packets sent by source stations; and
means for sending the aggregated packet to an address determined as a function of the target stations intended to receive the subset of the plurality of packets when the aggregated packet satisfies a determined transmission criterion.

13. A device for disaggregating an aggregated packet having a determined address in a packet mode data network, the packet mode data network comprising source stations sending a plurality of packets to respective target stations, said device comprising:
means for aggregating a subset of the plurality of packets into a single aggregated packet of the same protocol level as the subset, wherein the packets of the subset are chosen according to at least the size and the target station of each of the plurality of packets sent by source stations;
means for sending the aggregated packet to an address determined as a function of the target stations intended to receive the subset of the plurality of packets when the aggregated packet satisfies a determined transmission criterion;
means for receiving the aggregated packet;
means for extracting each packet of the subset from the received aggregated packet;
means for sending each extracted first packet to a respective target station.
